(19) United States
(12) Patent Application Publication
(10) Pub. No.: US 2003/0097556 A1
(43) Pub. Date: May 22, 2003

(54) Method and apparatus for providing simplified booting of domains in a multi-domain computer system

(76) Inventors: Gary L. Gilbert, San Diego, CA (US); Nicholas E. Aneshansley, San Diego, CA (US); Richard A. Rogers, San Diego, CA (US); Veronica A. Gauss, Watertown, MA (US)

Correspondence Address: B. NOEL KIVLIN, MEYERTONS, HOOD, KIVLIN, KOWERT & GOETZEL, PC, P.O. BOX 398, AUSTIN, TX, 78767-0398, US

(21) Appl. No.: 09/992,446

(22) Filed: Nov. 16, 2001

(51) Int. Cl. G06F 15/177

(52) U.S. Cl. 713/2

(57) ABSTRACT

A method and apparatus for booting a domain in a computer system configurable with a plurality of domains. The method includes locating one or more available boot locations on one or more local storage drives and identifying a boot location on a local storage drive. The method also includes booting the domain from the boot location on the local storage drive. The device includes a first connector and a bus bridge coupled to the first connector. A storage controller is coupled to the bus bridge. A storage device is coupled to the controller. The storage device is configured to boot a domain.

### BACKGROUND OF THE INVENTION

1. Field of the Invention

This invention relates generally to computer systems, and, more particularly, to a method and apparatus for providing simplified booting of domains in a multi-domain computer system.

2. Description of the Related Art

Network computing has increased dramatically over the past several years due in part to the emergence of the Internet. Some trends in the industry include a significant growth in Applications Service Providers (ASPs) that provide applications to businesses over networks that use the Internet, for example, to distribute product data to customers, take orders, and enhance communications between employees.

Typically, businesses rely on network computing to maintain a competitive advantage over other businesses. As such, developers typically take several factors into consideration to meet the customer's expectation when designing processor-based systems for use in network environments. Such factors, for example, may include functionality, reliability, scalability and the performance of these systems.

One example of a processor-based computer system used in a network environment is a mid-range server. A single mid-range server may be configured for a plurality of domains, where each domain may act as a separate machine by running its own instance of an operating system to perform one or more of the configured tasks.

The benefits of providing near-independent domains within an integrated system are readily apparent, as customers are able to perform a variety of tasks that would otherwise be reserved for several different machines. Because these domains typically share some of the computer system's resources, when one domain ceases to function properly, it may adversely affect the operation of the other domain(s). In addition, booting (or initializing) of each domain is typically an involved process using local processors and boot images stored on remote storage.

### SUMMARY OF THE INVENTION

In one aspect of the present invention, a device is provided. The device includes a first connector and a bus bridge coupled to the first connector. A storage controller is coupled to the bus bridge. A storage device is coupled to the controller.

In another aspect of the present invention, a computer system is provided. The computer system includes a center plane, one or more processor boards coupled to the center plane, and one or more I/O boards coupled to the center plane. The computer system also includes a device connected locally to a first I/O board of the one or more I/O boards. The device includes a storage controller and a storage device coupled to the storage controller.

In still another aspect of the present invention, another computer system is provided. This computer system includes a center plane, a plurality of processor boards coupled to the center plane, and a plurality of I/O boards coupled to the center plane. This computer system also includes a plurality of devices each connected locally to an I/O board of the plurality of I/O boards. Each of the plurality of devices includes a storage controller and a storage device coupled to the storage controller.

In yet another aspect of the present invention, a method of booting a domain in a computer system configurable with a plurality of domains is provided. The method includes booting the domain from a boot location on a local storage drive and loading operating system code from the boot location into one or more processors in the domain. The method also includes operating the domain from the one or more processors.

In another aspect of the present invention, another method of booting a domain in a computer system configurable with a plurality of domains is provided. This method includes locating one or more available boot locations on one or more local storage drives and identifying a boot location on a local storage drive of the one or more local storage drives. This method also includes booting the domain from the boot location on the local storage drive.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a block diagram of a multi-domain computer system in accordance with one embodiment of the present invention;

FIG. 2 shows a block diagram of an exemplary domain configuration, which may be employed in the system of FIG. 1, according to one embodiment of the present invention;

FIG. 3 illustrates a block diagram of an exemplary system board set coupled to a center plane, according to one embodiment of the present invention;

FIG. 4 illustrates an alternative I/O board, according to one embodiment of the present invention;

FIG. 5 illustrates a hot-swappable, bootable cassette, according to one embodiment of the present invention;

FIG. 6 illustrates the computer system of FIG. 1 in a typical arrangement, according to one embodiment of the present invention;

FIG. 7 shows a flowchart of a method of booting a computer system such as shown in FIG. 6, according to one embodiment of the present invention; and

FIG. 8 shows a flowchart of a method of booting a domain in a computer system configurable with a plurality of domains, according to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

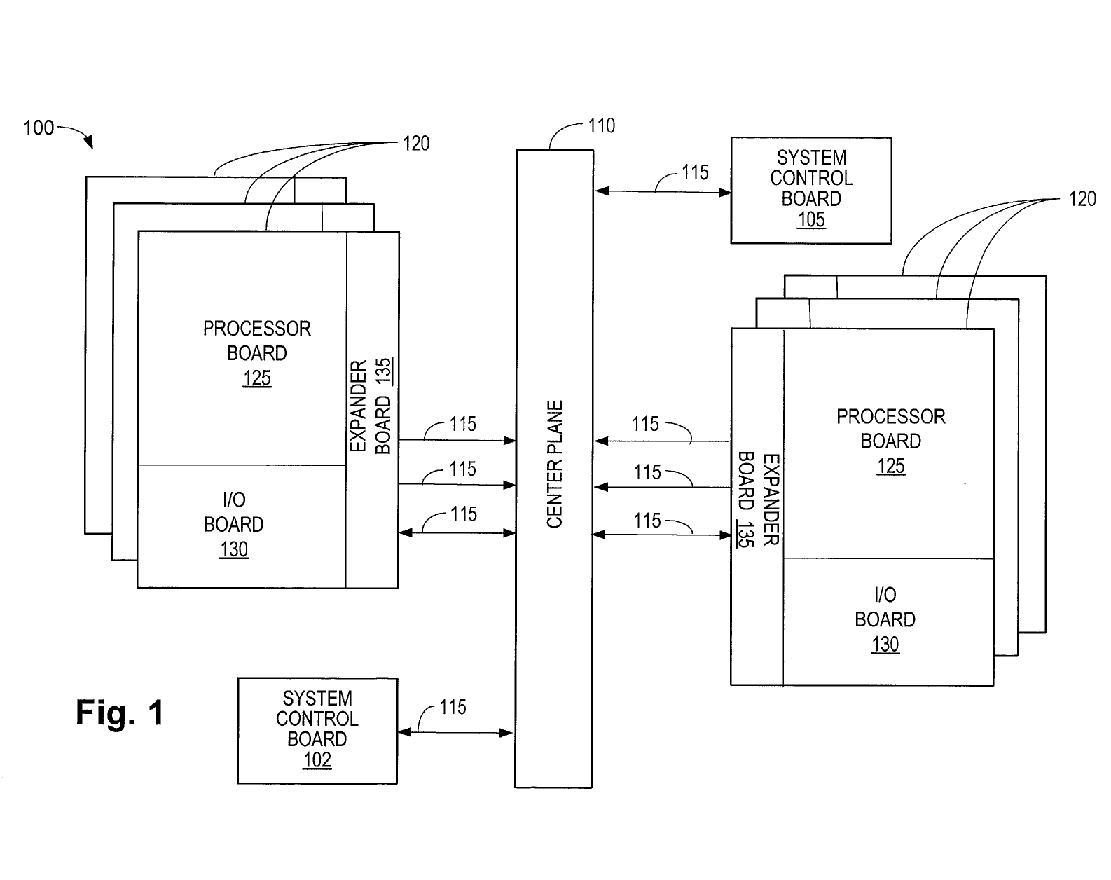

Turning now to the drawings, and specifically referring to FIG. 1, a simplified block diagram of a computer system 100, according to one embodiment of the present invention, is shown. The computer system 100 comprises a pair of system control boards 102, 105 coupled to a center plane 110 (e.g., a back plane or a switch) via a plurality of respective communication links 115. In one embodiment, the communication links 115 take the form of edge connectors for making electrical or optical connections. It will be appreciated, however, that the communication links 115 may alternatively take the form of cables or various other types of interfaces without departing from the scope of the present invention.

According to the illustrated embodiment, one of the system control boards 102 serves as the “primary” system control board for providing system controller resources for the computer system 100 and managing the overall operation thereof. Another “secondary” system control board 105, which may be functionally and/or structurally identical to the primary system control board 102, may serve as a backup for managing the system 100 if the primary system control board 102 fails or is otherwise made unavailable.

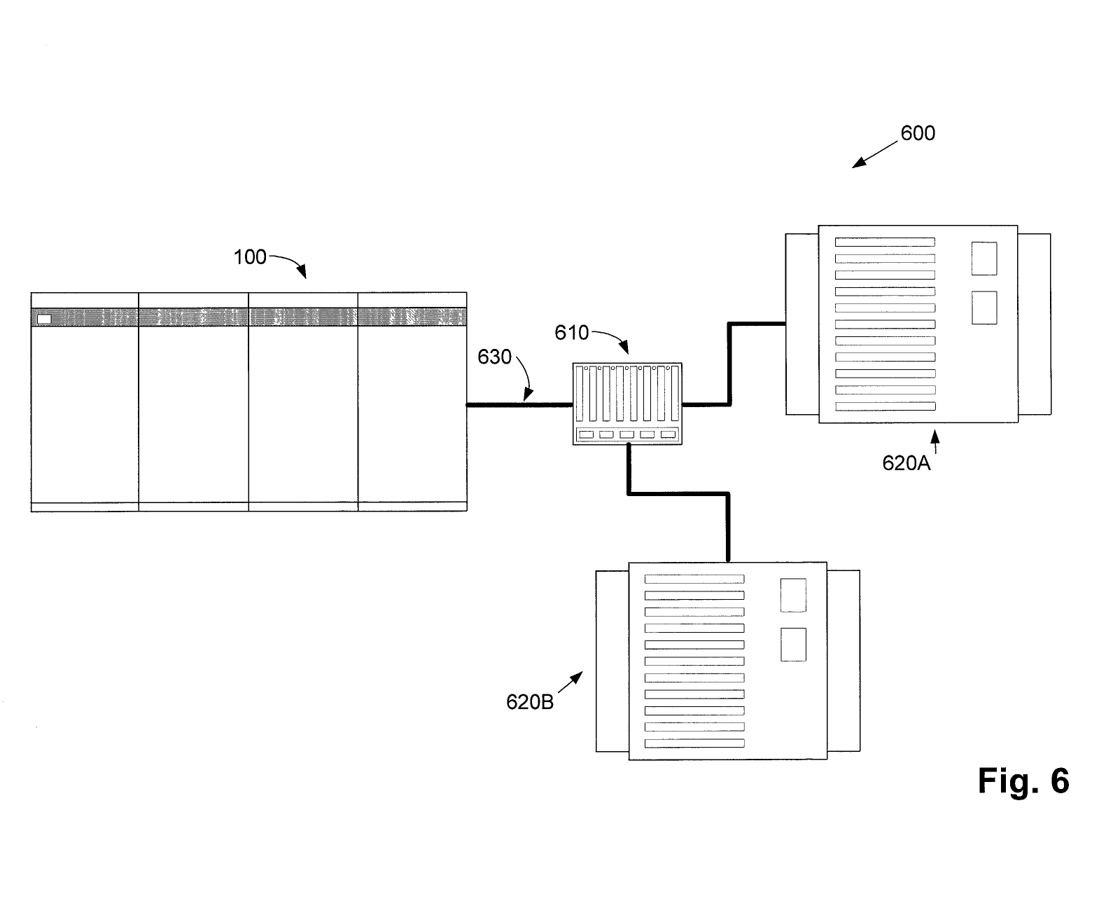

The computer system 100 further includes a plurality of system board sets 120, which are coupled to the center plane 110 via the plurality of respective communication links 115. The communication links 115 may include data links, command links, control links, address links, and testing links. The system board sets 120 each comprise one or more boards, which may include a processor board 125, an I/O board 130, and an expander board 135. The processor board 125, for example, may include a plurality of processors and/or memories for executing various computing tasks. The I/O board 130 may manage I/O cards, such as peripheral component interface (PCI) cards and optical cards that are installed in the system 100 for connection to various I/O devices, such as shown below with respect to FIG. 6.

According to the illustrated embodiment, the expander board 135 allows both the processor board 125 and I/O board 130 to interface with the center plane 110. In accordance with one embodiment, the computer system 100 may include up to a total of eighteen expander boards 135, with each expander board 135 having a slot for accommodating a processor board 125 and an I/O board 130, for a total of thirty-six boards 125, 130. It will be appreciated that the expander board 135 may alternatively be configured to accommodate various arrangements of processor boards 125 and I/O boards 130. That is, the expander board 135 may be alternatively configured to accommodate two processor boards 125 or one processor board 125 and one I/O board 130 (as shown in FIG. 1), without departing from the scope of the present invention. Additionally, it will be appreciated that the computer system 100 may be configured with a greater or fewer number of boards 125, 130, 135 than provided in the example above without departing from the scope of the present invention.

The center plane 110 serves as a communication medium for the plurality of system board sets 120 and system control boards 102, 105 to communicate with one another. According to one embodiment, the center plane 110 takes the form of a plurality of 18×18 crossbars to accommodate communications between the thirty-six boards 125, 130. Accordingly, the center plane 110 may permit the two system control boards 102, 105 to communicate with each other or with other system board sets 120, as well as allow the system board sets 120 to communicate with each other.

In accordance with one embodiment of the present invention, the system resources (e g., processor boards 125, I/O boards 130) of the computer system 100 may be dynamically subdivided into a plurality of system domains, where each domain may have a separate boot disk to execute a specific instance of an operating system, separate disk storage, network interfaces, and/or I/O interfaces. Each domain may essentially operate as a separate machine that performs a variety of user-configured services. For example, one or more domains may be designated as an application server, a web server, database server, etc. Alternatively, each domain may be allocated to a specific department within a company or organization. For example, one domain may be allocated to a marketing department and another domain may be allocated to an accounting department to accommodate their respective computing needs. Alternatively, the computer system 100 may be shared by a few smaller companies or organizations through a computer service company, where it would otherwise be impractical for any one company or organization to purchase and maintain the computer system 100. Thus, each such company or organization could be allocated a specific grouping of system resources from the system 100 (i.e., allocated one or more domains) for their individual use.

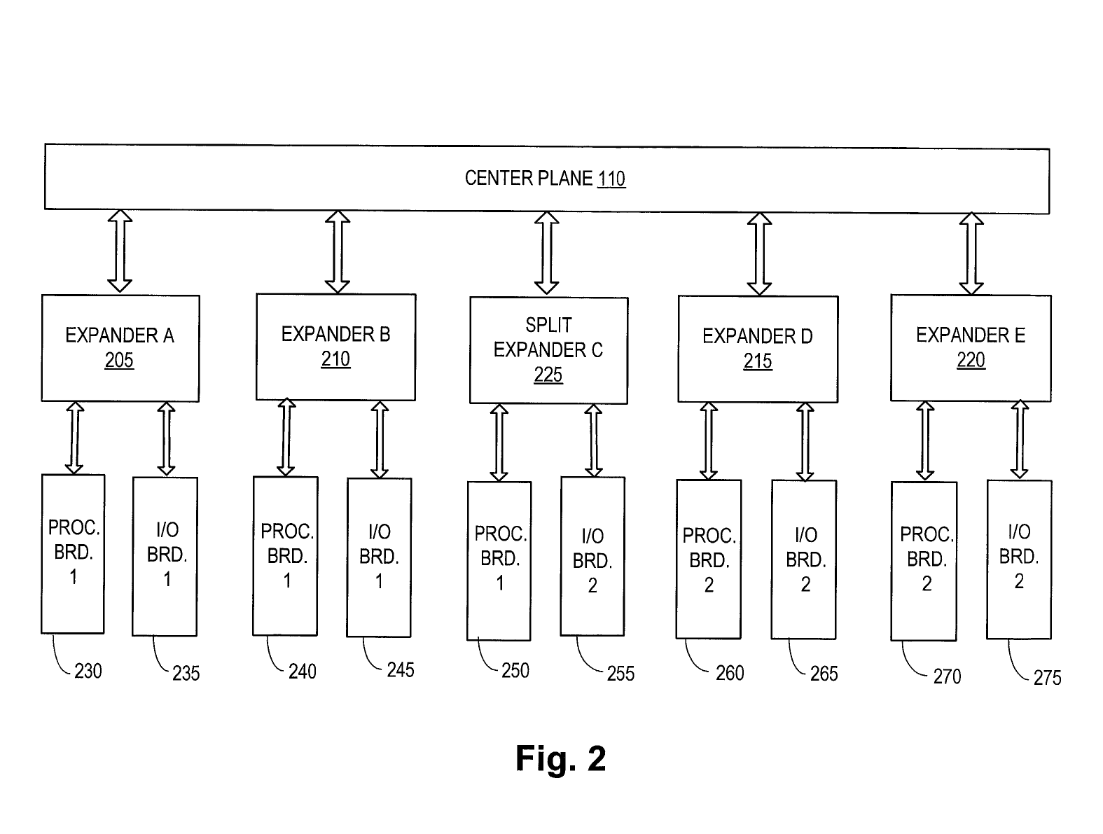

Turning now to FIG. 2, a block diagram of an exemplary domain configuration, which may be employed in the system of FIG. 1, according to one embodiment of the present invention, is shown. According to this embodiment, the system resources of the computer system 100 are divided into two domains. The first domain is identified by the numeral “1,” and the system resources (e.g., processor boards 125, I/O boards 130, etc.) that are allocated to the first domain are labeled accordingly. The second domain is identified by the numeral “2,” and its corresponding grouping of system resources are labeled by the numeral “2.”

As shown in FIG. 2, expander boards 205, 210 (i.e., expanders A and B) are each associated with processor boards 230, 240 and I/O boards 235, 245 that are allocated within domain 1. Expander boards 215, 220 (i.e., expanders D and E) are each associated with processor boards 260, 270 and I/O boards 265, 275 that are allocated within domain 2. As previously discussed, each domain defines a particular grouping of system resources within the computer system 100 to perform a particular task or set of tasks, which the domain is formed to accomplish.

When the expander board 135 is interfaced with a processor board 125 and I/O board 130 within the same domain, it is referred to as a “non-split” expander or a “non-split” slot. In the particular example provided in FIG. 2, the expander boards 205, 210 and the expander boards 215, 220 are non-split expanders because they are interfaced with system resources from a single domain. For example, the expander boards 205, 210 respectively interface with the processor boards 230, 240 and the I/O boards 235, 245 from the same domain (i.e., domain 1). Likewise, the expander boards 215, 220 interface with the processor boards 260, 270 and the I/O boards 265, 275 from the same domain (i.e., domain 2). The expander board 225 (i.e., expander C), on the other hand, interfaces with system resources from differing domains. That is, the expander board 225 is interfaced with the processor board 250 from domain 1 and the I/O board 255 from domain 2. When the expander board 135 is interfaced with system resources from differing domains, it is referred to as a “split” expander or “split” slot. Accordingly, in the example provided in FIG. 2, the expander board 225 is a split expander.

A domain may be formed of an entire system board set 120, one or more boards (e.g., processor board 125, I/O board 130) from selected system board sets 120, or a combination thereof. Additionally, it will be appreciated that physical proximity of the boards is not necessary to be within a particular domain. It will further be appreciated that the number of domains need not necessarily be limited to two as shown in the example of FIG. 2, but may include several additional domains. For example, it is conceivable for each system board set 120 within the system 100 to form its own respective domain. Alternatively, all system board sets 120 may form a single domain. It will also be appreciated that several other arrangements of the system resources may be formed, and, thus, need not be limited to the particular arrangement of system resources as illustrated in FIG. 2.

In accordance with the illustrated embodiment of the present invention, the system 100 is configured to perform intra-domain communication, i.e., communication solely within domain 1 and communication solely within domain 2, but not between domains 1 and 2. Typically, with intra-domain communication within the computer system 100, the transactions that occur in one domain on a non-split expander board do not affect the transactions that occur in the other domain because the expander board 135 interfaces solely with processor and/or I/O boards 125, 130 within one domain (i.e., either domain 1 or domain 2). Thus, the transactions for the processor board 250 (shown in FIG. 2) of domain 1 and the I/O board 255 of domain 2 that are coupled to the split expander 225 are independent of one another, i.e., communication occurs solely between the system resources within domain 1 and solely between the system resources of domain 2. With the split expander board 225, however, intra-domain communication of one domain may be adversely affected if the other domain is “down” (i.e., has failed). That is, because the split expander board 225 handles transactions for both domains, if one domain goes down (such as domain 1, for example), it may adversely affect the operation of the other domain (i.e., domain 2) sharing the split expander board 225. Accordingly, if the system resources for one domain go down, the system resources for the other domain may go down as well because of the two independent domains sharing the same expander board 135.

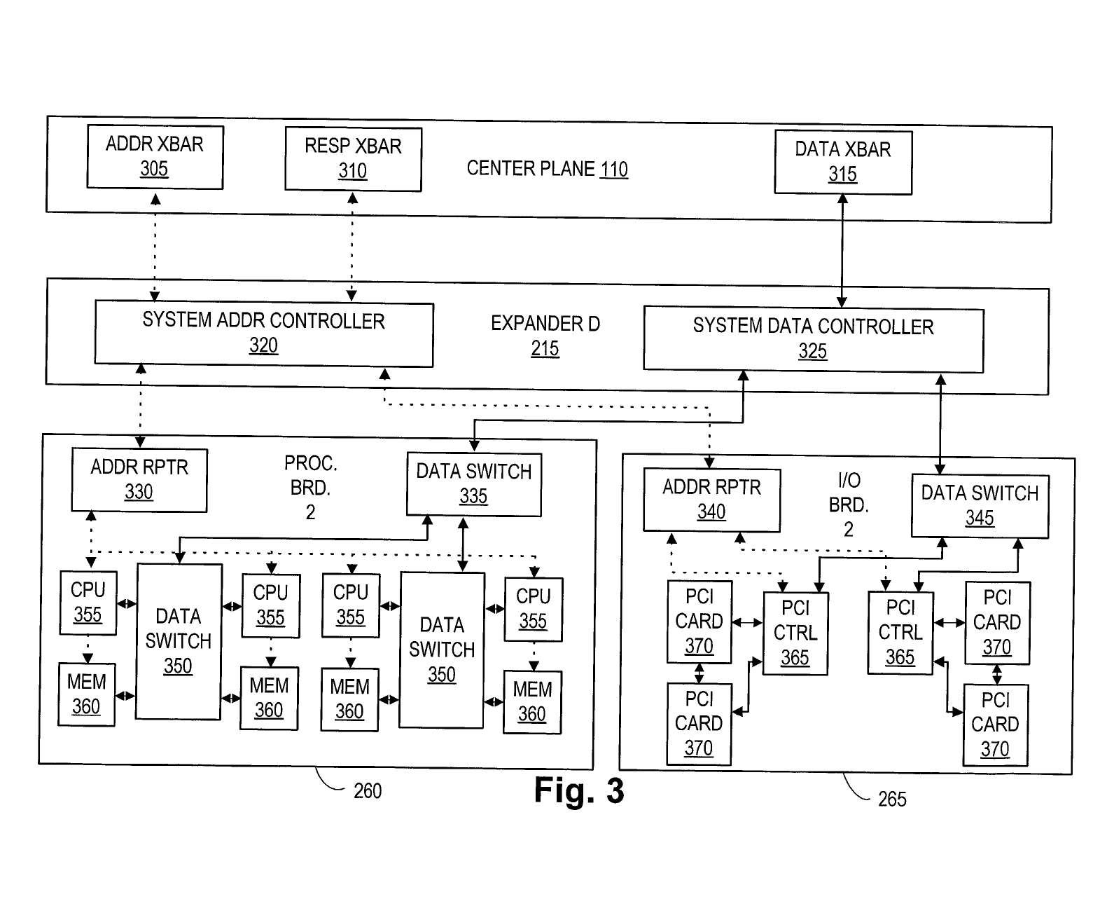

Turning now to FIG. 3, a block diagram of an exemplary system board set (expander board D 215, processor board 260, I/O board 265) coupled to the center plane 110, according to one embodiment of the present invention, is shown. The center plane 110 includes an address crossbar 305, a response crossbar 310, and a data crossbar 315. The expander board D 215 includes a system address controller 320 and a system data controller 325. The system address controller 320 is coupled to the address crossbar 305 and the response crossbar 310. The system data controller 325 is coupled to the data crossbar 315.

The illustrated embodiment of the processor board 260 includes an address repeater 330, a data switch 335, a plurality of processors (CPUs) 355, a plurality of memories 360, and a plurality of data switches 350. The address repeater 330 is coupled to receive address information from the system address controller 320. The address repeater 330 is also coupled to transmit address information to one or more CPUs 355. The data switch 335 is coupled to receive data from the system data controller 325. Each CPU 355 is coupled to receive address information from the address repeater 330 and provide address information to a respective memory 360. Each data switch 350 is coupled to receive data through the data switch 335. Each data switch 350 is also coupled to provide data to a plurality of the CPUs 355 and a plurality of the memories 360.

The illustrated embodiment of the I/O board 265 includes an address repeater 340, a data switch 345, a plurality of I/O controllers (e.g., PCI controllers) 365, and a plurality of I/O cards (e.g., PCI cards) 370. The address repeater 340 is coupled to receive address information from the system address controller 320. The address repeater 340 is also coupled to transmit address information to each PCI controller 365. The data switch 345 is coupled to receive data from the system data controller 325. Each PCI controller 365 is coupled to receive address information from the address repeater 340 and provide address information to a respective plurality of PCI cards 370. Each PCI controller 365 is also coupled to receive data through the data switch 345 and provide data to the respective plurality of PCI cards 370. Each of the respective plurality of PCI cards 370 is additionally configured to share data directly.

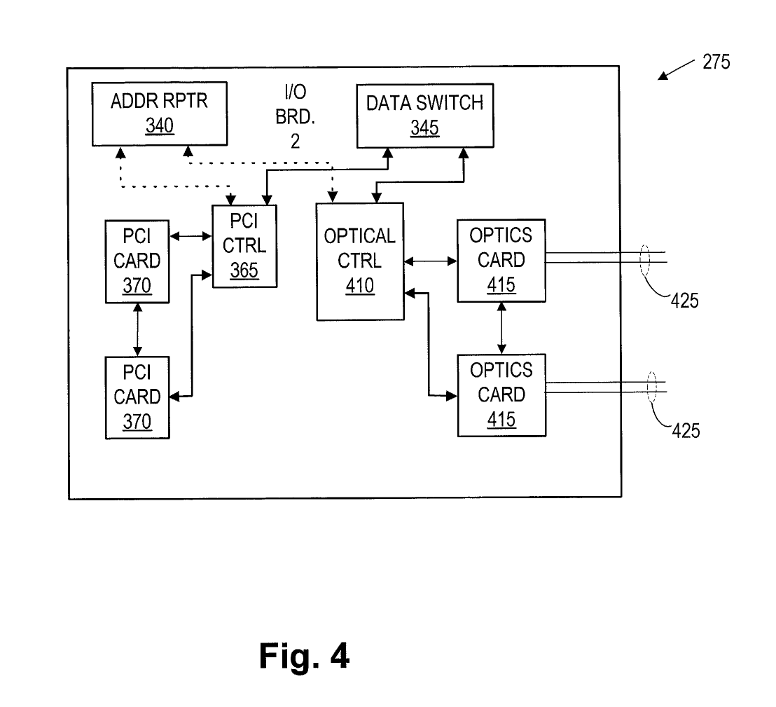

Referring to FIG. 4, an alternative I/O board 275, according to one embodiment of the present invention, is shown. The illustrated embodiment of the alternative I/O board 275 includes an address repeater 340, a data switch 345, a plurality of I/O controllers 365, 410, and a plurality of I/O cards 370, 415. The plurality of I/O controllers 365, 410 includes a PCI controller 365 and an optical controller 410. The plurality of I/O cards 370, 415 include a plurality of PCI cards 370 and a plurality of optical cards 415. The address repeater 340 may be coupled to receive address information from the system address controller 320. The address repeater 340 is also coupled to transmit address information to the PCI controller 365 and the optical controller 410. The data switch 345 may be coupled to receive data from the system data controller 325. The PCI controller 365 is coupled to receive address information from the address repeater 340 and provide address information to a respective plurality of PCI cards 370. Each PCI controller 365 is also coupled to receive data through the data switch 345 and provide data to the respective plurality of PCI cards 370. Each of the respective plurality of PCI cards 370 is additionally configured to share data directly. The optical controller 410 is coupled to receive address information from the address repeater 340 and provide address information to a respective plurality of optical cards 415. The optical controller 410 is also coupled to receive data through the data switch 345 and provide data to the respective plurality of optical cards 415. Each of the respective plurality of optical cards 415 is additionally configured to share data directly. Each optical card 415 is configured to exchange data over optical data lines 425.

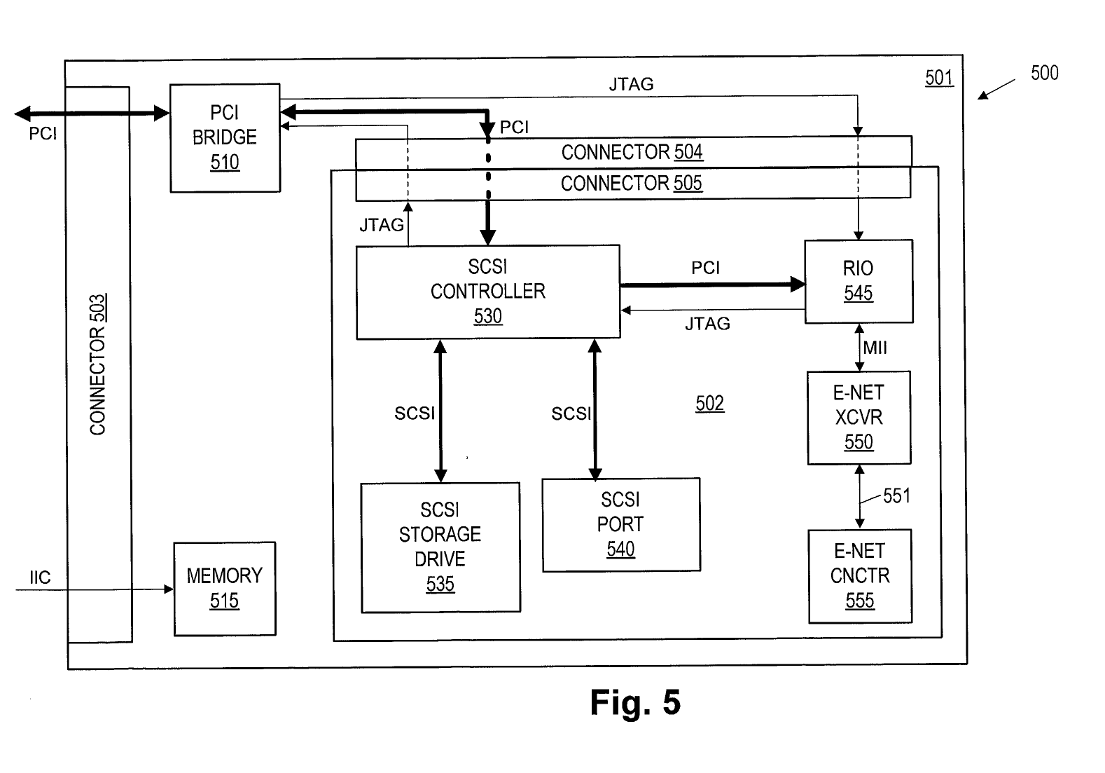

Turning now to FIG. 5, a hot-swappable, bootable cassette 500, according to one embodiment of the present invention, is shown. In the illustrated embodiment, the cassette 500 is an embodiment of a hot-swappable carrier for one of the PCI cards 370 shown in FIGS. 3 and 4. The cassette 500 includes a connector 503 for connecting to the PCI controller 365, shown in FIGS. 3 and 4. The signal carriers in the connector 503 convey PCI signals to a PCI bridge 510 and two-wire serial (e.g., IIC, SMBus, etc.) signals to a memory 515, in the illustrated embodiment. The PCI bridge 510 is shown coupled through a connector pair 504 and 505 to a plurality of I/O (or storage) controllers, a SCSI (Small Computer Systems Interface, ANSI X3.131-1986) controller 530 using PCI and JTAG (see below) signals and a RIO™ ASIC 545 using JTAG signals. The SCSI controller 530 and the RIO™ ASIC (Application Specific Integrated Circuit) 545 are further coupled through PCI and JTAG signals. The SCSI controller 530 is coupled to a SCSI storage device 535 and a SCSI port 540 on the SCSI bus. The RIO™ ASIC 545 couples to an Ethernet transceiver (PHY) 550 through an MII (Media-Independent Interface). The Ethernet transceiver 550 is coupled to an Ethernet connector 555 on an Ethernet line 551, such as can be configured as 100BaseTX, etc.

In one embodiment, the SCSI storage device 535 is a hard disk drive. The hard disk drive may be a bootable device, capable of booting a domain in the multiple domain computer system 100. In other embodiments, the SCSI storage device 535 may be other types of bootable storage devices, such as flash memory configured as an electronic hard drive, etc.

Note that JTAG is well known in the art, referring to IEEE Standard 1149.1-1990 Test Access Port and Boundary-Scan Architecture and successors for the testing of internal interconnections. The RIO™ ASIC 545, available from SUN MICROSYSTEMS of Palo Alto, Calif., is a high performance I/O controller chip including an IEEE 802.3 MAC (Media Access Controller).

In one embodiment, the memory 515 is a SEEPROM (Serial Electrically Erasable Programmable ROM) configured with manufacturing information, serial numbers, and/or configuration data. The IIC connection shown may be implemented in any desired protocol and is not restricted to the two-wire serial connection illustrated.

Note that the hot-swappable, bootable cassette 500 shown in FIG. 5 is not the only embodiment of a hot-swappable cassette contemplated for use with the I/O boards 130, 235, 245, 255, 265, 275. For example, one hot-swappable cassette contemplated includes a PCI slot for connecting any PCI board to the respective I/O board 130, 235, 245, 255, 265, 275. Other, more specialized hot-swappable cassettes are also contemplated.

Turning now to FIG. 6, the computer system 100 of FIG. 1 is shown in a typical arrangement 600, according to one embodiment of the present invention. The computer system 100 is coupled through a high bandwidth communications connection 630, and an optional local router 610, to remote storage arrays 620A and 620B.

Remote storage arrays 620A and 620B store data and code for the computer system 100. Remote storage locations on the remote storage arrays 620A and 620B may include bootable images and OS code for domains in the computer system 100. According to one embodiment of the present invention, the computer system 100 may find bootable locations locally in the computer system 100 and/or remotely in the remote storage arrays 620A and 620B.

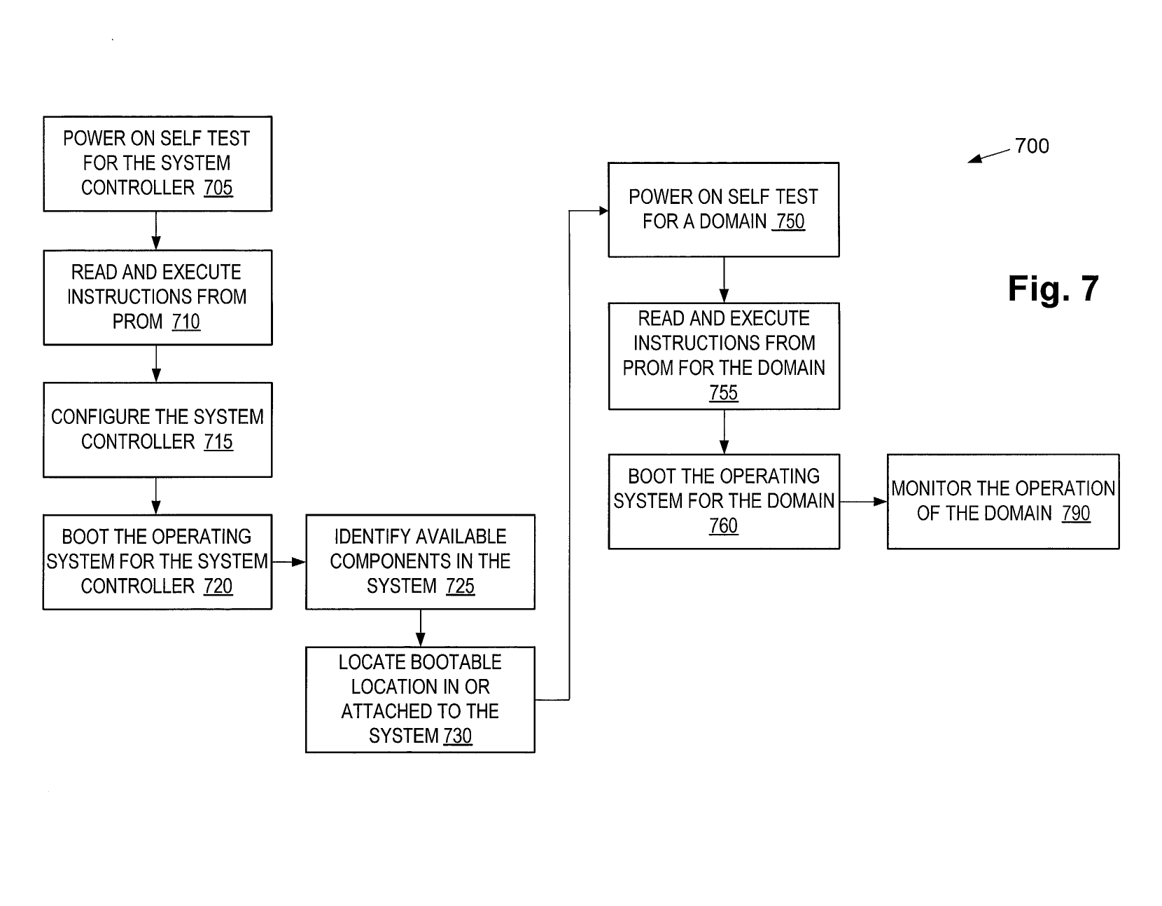

Turning now to FIG. 7, a flowchart of a method 700 of booting a computer system 100 such as shown in FIGS. 1 and 6, according to one embodiment of the present invention, is shown. The method 700 includes a power-on self-test (POST) for a system controller, such as system control boards 102, 105 shown in FIG. 1, in block 705. The method 700 also includes reading and executing instructions for the system controller from a PROM (Programmable ROM), in block 710. In block 715, the method 700 configures the system controller, such as system controllers 102 and 105. In block 720, an operating system for the system controller is booted.

The method 700 identifies available components in the computer system 100, in block 725. The method 700 locates bootable locations within or remotely attached to the computer system 100, in block 730.

The method 700 performs a POST for the identified components in the computer system 100 that will be part of a domain, in block 750. The method 700 then executes the instructions in the PROM for the domain, in block 755.

The method 700 boots an operating system for the domain, in block 760. The system controller monitors the domain as the domain executes, in block 790.

Note that multiple domains may be sequentially created using the method 700 and not just a single domain. The system controller 102, 105 may have additional functions, such as re-configuring domains or restarting failed domains, other than those described in method 700.

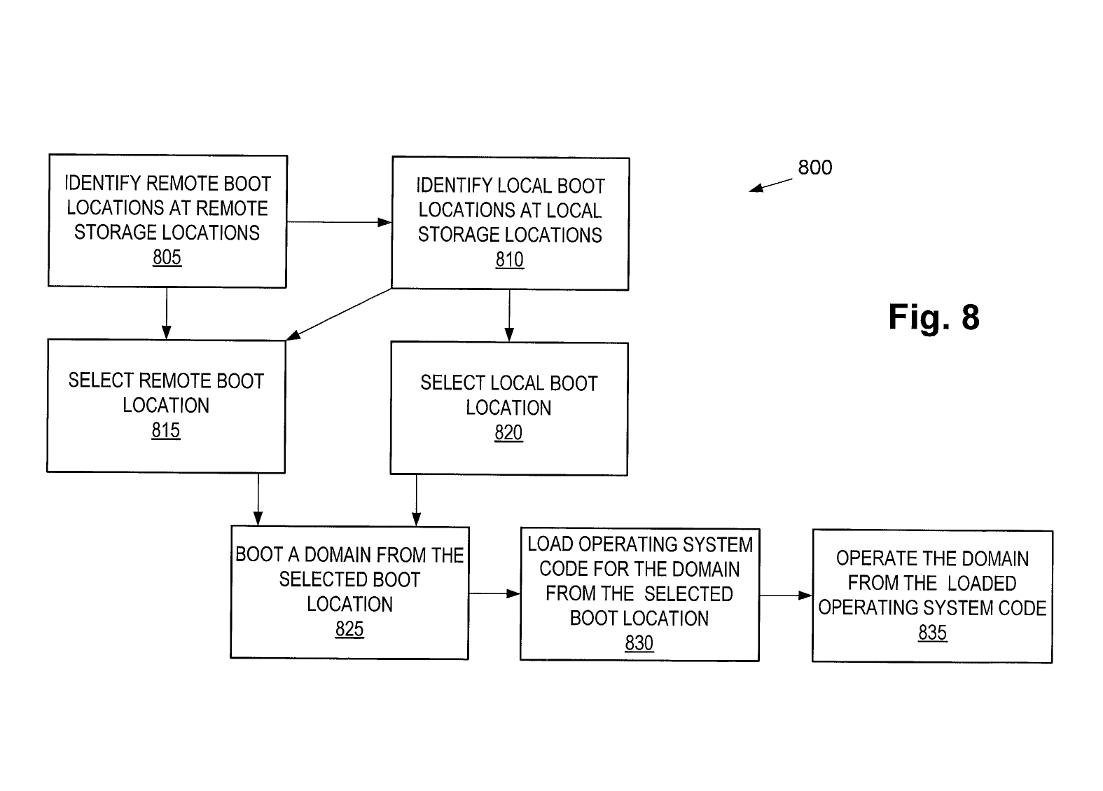

Turning now to FIG. 8, a flowchart of a method 800 of booting a domain in a computer system configurable with a plurality of domains, according to one embodiment of the present invention, is shown. The method 800 includes identifying one or more remote boot locations at remote storage locations, at block 805. The method also includes identifying one or more local boot locations at local storage locations, at block 810. The method may include selecting one of the remote boot locations for booting the domain, at block 815. The method may include selecting one of the local boot locations for booting the domain, at block 820.

Once a boot location has been selected, the method 800 includes booting the domain from the selected boot location, at block 825. The method 800 includes loading operating system code for the domain from the selected boot location, at block 830. The operating system code for the domain may be loaded into one or more processors within the domain. The method 800 also includes operating the domain from the loaded operating system code, at block 835.

Note that while the methods 700, 800 of the present invention disclosed herein have been illustrated as flowcharts, various elements of the flowcharts may be omitted or performed in a different order in various embodiments. Note also that the methods 700, 800 of the present invention disclosed herein admit to variations in implementation.

Some aspects of the present invention, as disclosed above, may be implemented in hardware or software. Thus, some portions of the detailed descriptions herein are consequently presented in terms of a hardware implemented process and some portions of the detailed descriptions herein are consequently presented in terms of a software-implemented process involving symbolic representations of operations on data bits within a memory of a computing system or computing device. These descriptions and representations are the means used by those in the art to convey most effectively the substance of their work to others skilled in the art using both hardware and software. The process and operation of both require physical manipulations of physical quantities. In software, usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software-implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A device, comprising:
a first connector;
a bus bridge coupled to the first connector;
a storage controller coupled to the bus bridge; and
a bootable storage device connected to the storage controller, wherein the bootable storage device is operable to boot a domain in a multiple domain computer system.

2. The device of claim 1, further comprising:
an I/O controller coupled to the storage controller; and
a network interface.

3. The device of claim 2, further comprising;
an I/O port coupled to the storage controller.

4. The device of claim 2, wherein the network interface comprises an Ethernet transceiver coupled to the I/O controller.

5. The device of claim 4, further comprising:
an Ethernet connector coupled to the Ethernet transceiver.

6. The device of claim 2, wherein the I/O controller is coupled to the bus bridge.

7. The device of claim 1, further comprising:
a storage port coupled to the storage controller.

8. The device of claim 1, configured as a primary card including the first connector and the bus bridge, and the primary card further comprising:
a second connector coupled between the bus bridge and the storage controller; and configured as a secondary card including the storage controller and the bootable storage device, and the secondary card further comprising:
a third connector coupled to the second connector, wherein the bus bridge and the storage controller are coupled through the third connector.

9. The device of claim 1, further comprising:
a memory coupled to the first connector, wherein the first memory is configured to store configuration data for the device.

10. A computer system, comprising:
a center plane;
one or more processor boards coupled to the center plane;
one or more I/O boards coupled to the center plane; and
a device connected locally to a first I/O board of the one or more I/O boards, the device comprising:
a storage controller; and
a storage device coupled to the storage controller.

11. The computer system of claim 10, the device further comprising:
an I/O controller coupled to the device controller; and
an Ethernet transceiver coupled to the I/O controller.

12. The computer system of claim 10, the device further comprising;
a storage port coupled to the storage controller.

13. The computer system of claim 10, the device configured as a primary card and a secondary card, the primary card comprising:
a first connector configured to couple the primary card to the first I/O board;
a bus bridge coupled to the first I/O board through the first connector; and
a second connector coupled between the bus bridge and the storage controller; and
the secondary card including the storage controller and the storage device, the secondary card further comprising:
a third connector connected to the second connector, wherein the bus bridge and the storage controller are coupled through the third connector.

14. The computer system of claim 10, wherein the storage device is a bootable device.

15. The computer system of claim 14, wherein the bootable device is operable to boot a domain.

16. The computer system of claim 10, the device further comprising:
a memory configured to store configuration data for the device.

17. The computer system of claim 10, wherein the one or more processor boards includes a plurality of processor boards coupled to the center plane.

18. The computer system of claim 10, wherein the one or more I/O boards includes a plurality of I/O boards coupled to the center plane.

19. The computer system of claim 18, further comprising:
one or more additional devices each connected locally to an I/O board of the plurality of I/O boards, each of the one or more additional devices comprising:
a storage controller; and
a storage device coupled to the storage controller.

20. A computer system, comprising:
a plurality of processors comprised locally within the computer system;
a plurality of storage controllers coupled to the plurality of processors, wherein the plurality of storage controllers are comprised locally within the computer system; and
one or more bootable storage devices, each coupled to a respective one of the plurality of storage controllers, wherein the one or more bootable storage devices are comprised locally within the computer system.

21. A method of booting a domain in a computer system configurable with a plurality of domains, the method comprising:
booting the domain from a boot location on a local storage drive;
loading operating system code from the boot location into one or more processors in the domain; and
operating the domain from the one or more processors.

22. The method of claim 21, further comprising:
booting a system controller; and
wherein booting the domain from the boot location on the local storage drive comprises the system controller booting the domain from the boot location on the local storage drive.

23. A method of booting a domain in a computer system configurable with a plurality of domains, the method comprising:
locating one or more available boot locations on one or more local storage drives;
identifying a boot location on a local storage drive of the one or more local storage drives; and
booting the domain from the boot location on the local storage drive.

24. The method of claim 23, further comprising:
locating one or more available boot locations on one or more remote drives.

25. The method of claim 23, further comprising:
loading operating system code from the boot location into one or more processors in the domain.

26. A device, comprising:
means for connecting the device to a computer system;
means for bridging to a bus in the computer system coupled through the means for connecting to the computer system;
means for controlling a means for storing data, wherein the means for controlling is coupled to the means for bridging.

27. The device of claim 26, wherein the means for storing data comprises a bootable means for storing data.

28. The device of claim 27, wherein the bootable means for storing data is operable to boot a domain in the computer system.

29. A computer readable medium encoded with instructions that, when executed by a computer system, performs a method for booting a domain in a computer system configurable with a plurality of domains in the computer system, the method comprising:
booting the domain from a boot location on a local storage drive;
loading operating system code from the boot location into one or more processors in the domain; and
operating the domain from the one or more processors.

30. The computer readable medium of claim 29, the method further comprising:
booting a system controller; and
wherein booting the domain from the boot location on the local storage drive comprises the system controller booting the domain from the boot location on the local storage drive.

31. A computer readable medium encoded with instructions that, when executed by a computer system, performs a method for booting a domain in a computer system configurable with a plurality of domains in the computer system, the method comprising:
locating one or more available boot locations on one or more local storage drives;
identifying a boot location on a local storage drive of the one or more local storage drives; and
booting the domain from the boot location on the local storage drive.

32. The computer readable medium of claim 31, the method further comprising:
locating one or more available boot locations on one or more remote drives.

33. The computer readable medium of claim 31, the method further comprising:
loading operating system code from the boot location into one or more processors in the domain.
